(19) United States
(12) Patent Application Publication
(10) Pub. No.: US 2026/0128539 A1
(43) Pub. Date: May 7, 2026

(54) CONNECTOR MODULE

(71) Applicant: Bellwether Electronic Corp., Taoyuan City (TW)

(72) Inventors: Jimmy Enrique ACERA, Taoyuan City (TW); Chih-Ming TSAI, Taoyuan City (TW)

(21) Appl. No.: 19/370,789

(22) Filed: Oct. 28, 2025

Related U.S. Application Data
(60) Provisional application No. 63/714,869, filed on Nov. 1, 2024.

(30) Foreign Application Priority Data
Aug. 5, 2025 (TW) 114129816

(51) Int. Cl. H01R 12/72; H01R 25/14

(52) U.S. Cl. CPC H01R 12/722; H01R 25/142

(57) ABSTRACT

A connector module includes a busbar clip connector, a busbar connector, a busbar assembly, a cable connector and a cable assembly. The busbar assembly is connected with the busbar connector and a side of the busbar clip connector. The cable assembly is connected with the cable connector and another side of the busbar clip connector.

### RELATED APPLICATIONS

This application claims priority to U.S. Provisional Application Ser. No. 63/714,869, filed Nov. 1, 2024, and Taiwanese Application Serial Number 114129816, filed Aug. 5, 2025, the disclosures of which are incorporated herein by reference in their entireties.

### BACKGROUND

### Technical Field

The present disclosure relates to connector modules, and more particularly to connector modules capable of transmitting a higher current flow.

### Description of Related Art

As the pace of modern life continues to accelerate, the demand for electronic devices has been steadily increasing. Facing to a huge consumer market, major manufacturers are focusing on enhancing the functionality and performance of their products, in order to boost the market competitiveness of their brands.

Taking power connectors as an example, the measure to effectively reduce their size to save space at a low cost while enhancing their utilization flexibility and allowing a higher current flow under a safe condition, is undoubtedly an important issue that the industry high concerns about, which is also a target required for an urgent improvement in related fields.

### SUMMARY

A technical aspect of the present disclosure is to provide a connector module, which can effectively enhance the flexibility in equipment assembly applications.

According to an embodiment of the present disclosure, a connector module includes a busbar clip connector, a busbar connector, a busbar assembly, a cable connector and a cable assembly. The busbar assembly is connected with the busbar connector and a side of the busbar clip connector. The cable assembly is connected with the cable connector and another side of the busbar clip connector.

In one or more embodiments of the present disclosure, the busbar assembly includes a plurality of busbars. The busbars are respectively connected between the busbar connector and the busbar clip connector. The cable assembly includes a plurality of cables. The cables are respectively connected between the cable connector and the busbar clip connector. A stiffness of each of the busbars is greater than a stiffness of each of the cables.

In one or more embodiments of the present disclosure, at least one of the busbars includes a first sub-busbar, a second sub-busbar and a bending portion. The first sub-busbar is connected to the busbar connector. The second sub-busbar is connected to the busbar clip connector. The bending portion is connected between the first sub-busbar and the second sub-busbar. The bending portion is at least partially bent.

In one or more embodiments of the present disclosure, the busbar connector includes a first housing, a plurality of first conductive portions and a plurality of first conductive sleeves. The first housing is configured to connect to a first panel. The first conductive portions are at least partially disposed within the first housing and respectively have a first accommodating hole. The first conductive sleeves are disposed within the first accommodating holes. At least one of the busbars is connected to one of the first conductive portions. At least another one of the busbars is connected to another one of the first conductive portions. The cable connector includes a second housing, a plurality of second conductive portions and a plurality of second conductive sleeves. The second housing is configured to connect to a second panel. The second conductive portions are at least partially disposed within the second housing and respectively have a second accommodating hole. The second conductive sleeves are disposed within the second accommodating holes. At least one of the cables is connected to one of the second conductive portions. At least another one of the cables is connected to another one of the second conductive portions.

In one or more embodiments of the present disclosure, the connector module further includes a plurality of board end connectors. The board end connectors respectively include a third housing and a plurality of plug terminals. The third housing is configured to connect to a circuit board. The plug terminals respectively include a third conductive portion and a plug portion. The third conductive portion is at least partially disposed within the third housing and configured to electrically connect to the circuit board. The plug portion extends from the third conductive portion. The plug portions of at least one of the board end connectors are configured to be inserted into one of the first conductive sleeves or the second conductive sleeves. The plug portions of at least another one of the board end connectors are configured to be inserted into another one of the first conductive sleeves or the second conductive sleeves.

In one or more embodiments of the present disclosure, the plug portion of one of the plug terminals and the plug portion of at least another one of the plug terminals have different heights relative to the circuit board in a normal direction of the circuit board and are offset from each other at a level parallel with the circuit board.

In one or more embodiments of the present disclosure, the busbar connector further includes at least one first limiting portion, at least one second limiting portion and a first locking member. The first limiting portion and the second limiting portion are respectively disposed outside the first housing and offset from each other along a first direction. The first locking member is disposed on the first housing and at least partially located on a side of the second limiting portion away from the first limiting portion in the first direction. The first locking member is configured to move relative to the first housing along the first direction to switch between a first unlocked state and a first locked state.

In one or more embodiments of the present disclosure, the cable connector further includes at least one third limiting portion, at least one fourth limiting portion and a second locking member. The third limiting portion and the fourth limiting portion are respectively disposed outside the second housing and offset from each other along a second direction. The second locking member is disposed on the second housing and at least partially located on a side of the fourth limiting portion away from the third limiting portion in the second direction. The second locking member is configured to move relative to the second housing along the second direction to switch between a second unlocked state and a second locked state.

In one or more embodiments of the present disclosure, the busbar clip connector includes a fourth housing and a plurality of terminal sets. The terminal sets are at least partially disposed within the fourth housing and spaced apart from each other. At least one of the busbars is connected to one of the terminal sets. At least another one of the busbars is connected to another one of the terminal sets. At least one of the cables is connected to one of the terminal sets. At least another one of the cables is connected to another one of the terminal sets. The fourth housing is configured to connect to a third panel.

In one or more embodiments of the present disclosure, the busbar clip connector further includes at least one fifth limiting portion, at least one sixth limiting portion and a pressing member. The fifth limiting portion and the sixth limiting portion are respectively disposed outside the fourth housing and spaced apart from each other. The pressing member is disposed on the fourth housing and at least partially located on a side of the sixth limiting portion away from the fifth limiting portion. The pressing member is configured to move relative to the fourth housing to switch between a third unlocked state and a third locked state.

According to an embodiment of the present disclosure, a connector module includes a busbar clip connector, a busbar connector, a plurality of busbars, a cable connector and a plurality of cables. The busbar clip connector is connected to a chassis. The busbar connector is connected to the chassis. The busbars are respectively connected between the busbar connector and a side of the busbar clip connector. Each of the busbars has a first sectional profile defining a first moment of inertia. The cable connector is connected to the chassis. The cables are respectively connected between the cable connector and another side of the busbar clip connector. Each of the cables has a second sectional profile defining a second moment of inertia. The first moment of inertia is larger than the second moment of inertia.

In one or more embodiments of the present disclosure, the busbars are respectively plate-shaped, while the cables are respectively wire-shaped.

In one or more embodiments of the present disclosure, the first sectional profile has two long edges and two short edges alternatively connected with each other. The busbars are arranged along an extending direction of the short edges.

In one or more embodiments of the present disclosure, the busbar connector and the busbar clip connector are spaced apart from each other by a first distance. The cable connector and the busbar clip connector are spaced apart from each other by a second distance. The first distance and the second distance are different from each other.

In one or more embodiments of the present disclosure, the connector module further includes a plurality of board end connectors. The board end connectors are respectively connected to a circuit board and configured to connect to one of the busbar connector and the cable connector.

In one or more embodiments of the present disclosure, the connector module further includes a grounding wire. The grounding wire is connected between the busbar clip connector and the chassis.

The above-mentioned embodiments of the present disclosure have at least the following advantages:
(1) Since the busbar connector connected to one side of the busbar clip connector is connected via the busbar assembly, while the cable connector connected to the other side of the busbar clip connector is connected via the cable assembly, with the stiffness of each of the busbars of the busbar assembly being greater than the stiffness of each of the cables of the cable assembly, the flexibility of the connector module in equipment assembly applications is effectively enhanced.
(2) Since the first distance of the busbar connector from the busbar clip connector and the second distance of the cable connector from the busbar clip connector are different from each other, the flexibility of the connector module in equipment assembly applications is further enhanced.
(3) Since the plug portions of each of the board end connectors are arranged in an inclined manner, this does not only effectively reduce the width of the board end connector but also provide a foolproof effect when connecting the board end connector to the busbar connector or the cable connector.
(4) Since the processes of assembling and disassembling the busbar clip connector to the third panel of the chassis, the busbar connector to the first panel of the chassis, and the cable connector to the second panel of the chassis do not involve additional hand tools, it is convenient for users.

### BRIEF DESCRIPTION OF THE DRAWINGS

The disclosure can be more fully understood by reading the following detailed description of the embodiments, with reference made to the accompanying drawings as follows:

FIGS. 1-2 are perspective schematic views from different visual angles of a connector module according to an embodiment of the present disclosure, in which the connector module is mounted on a chassis, while the busbar connector and the cable connector are not connected to the corresponding board end connectors;

FIG. 3 is a partially enlarged schematic view of the connector module of FIG. 1;

FIG. 4 is a schematic view of an internal structure of the connector module of FIG. 3;

FIG. 5 is an enlarged schematic view of the busbar clip connector of FIG. 1, in which the pressing member is in a third unlocked state;

FIG. 6 is a sectional view along the sectional line C-C of FIG. 5, in which the pressing member is in a third locked state;

FIG. 7 is a sectional view along the sectional line A-A of FIG. 1;

FIG. 8A is an enlarged schematic view of the busbar connector of FIG. 1, in which the first locking member is in a first unlocked state;

FIG. 8B is an enlarged schematic view of the busbar connector of FIG. 1, in which the first locking member is in a first locked state;

FIG. 9 is a sectional view along the sectional line B-B of FIG. 1;

FIG. 10A is an enlarged schematic view of the cable connector of FIG. 1, in which the second locking member is in a second unlocked state;

FIG. 10B is an enlarged schematic view of the cable connector of FIG. 1, in which the second locking member is in a second locked state;

FIG. 11 is an enlarged schematic view of the board end connector of FIG. 1;

FIG. 12 is a sectional view along the sectional line D-D of FIG. 11; and

FIG. 13 is an enlarged schematic view of the busbar connector and the corresponding board end connector of FIG. 1 after being connected together.

### DETAILED DESCRIPTION

Drawings will be used below to disclose embodiments of the present disclosure. For the sake of clear illustration, many practical details will be explained together in the description below. However, it is appreciated that the practical details should not be used to limit the claimed scope. In other words, in some embodiments of the present disclosure, the practical details are not essential. Moreover, for the sake of drawing simplification, some customary structures and elements in the drawings will be schematically shown in a simplified way. Wherever possible, the same reference numbers are used in the drawings and the description to refer to the same or like parts.

Unless otherwise defined, all terms (including technical and scientific terms) used herein have the same meanings as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

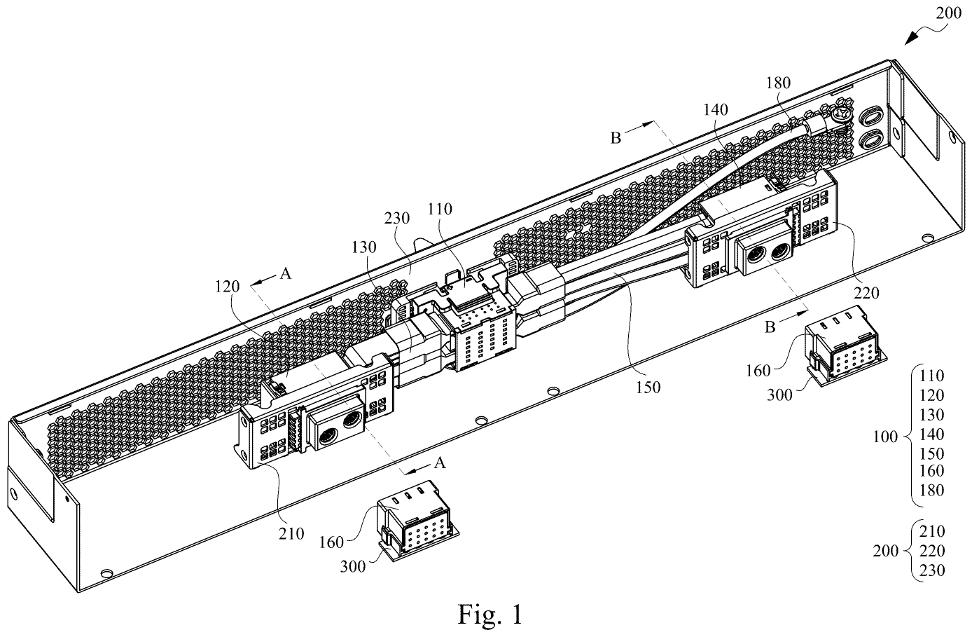

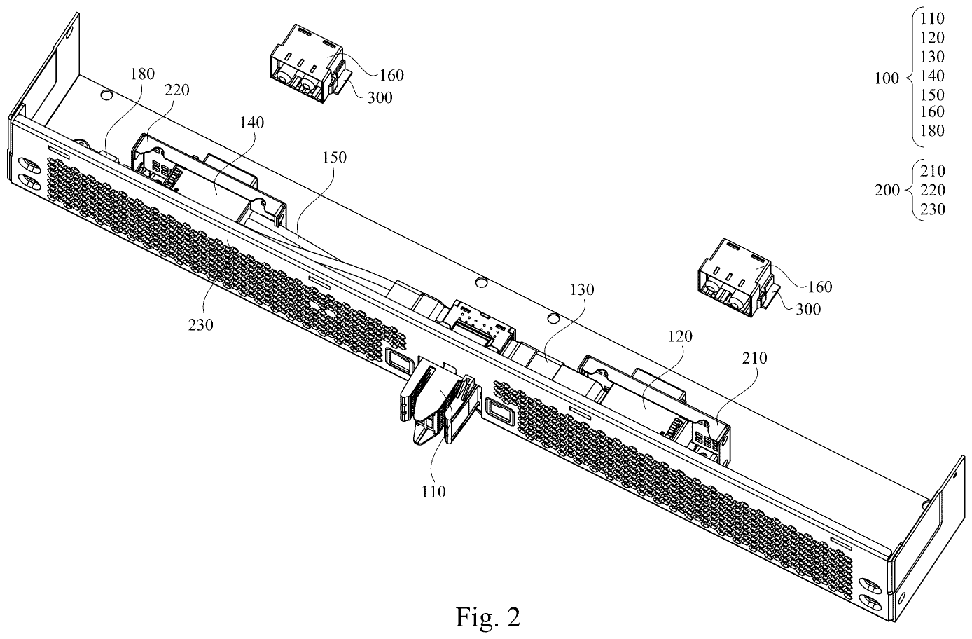

Please refer to FIGS. 1-2. FIGS. 1-2 are perspective schematic views from different visual angles of a connector module 100 according to an embodiment of the present disclosure, in which the connector module 100 is mounted on a chassis 200, while the busbar connector 120 and the cable connector 140 are not connected to the corresponding board end connectors 160. In this embodiment, as shown in FIGS. 1-2, a connector module 100 is suitable to be mounted on a chassis 200. For the sake of drawing simplification, FIGS. 1-2 illustrate only a portion of the chassis 200. In practice, the chassis 200 may be, for example, the housing of a server, and the chassis 200 includes a first panel 210, a second panel 220, and a third panel 230. The connector module 100 includes a busbar clip connector 110, a busbar connector 120, a busbar assembly 130, a cable connector 140 and a cable assembly 150. The busbar clip connector 110 is connected to the third panel 230. The busbar connector 120 is connected to the first panel 210, while the busbar assembly 130 is connected to the busbar connector 120 and a side of the busbar clip connector 110. The cable connector 140 is connected to the second panel 220, while the cable assembly 150 is connected to the cable connector 140 and another side of the busbar clip connector 110. In other words, the busbar assembly 130 and the cable assembly 150 are connected to opposite sides of the busbar clip connector 110. Moreover, the busbar clip connector 110 may be connected to the chassis 200, for example, to the third panel 230, via a grounding wire 180.

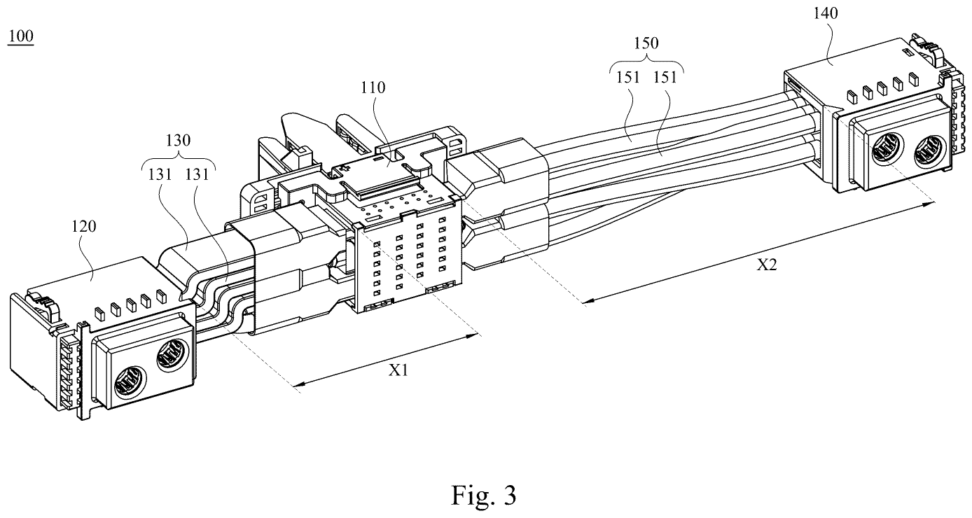

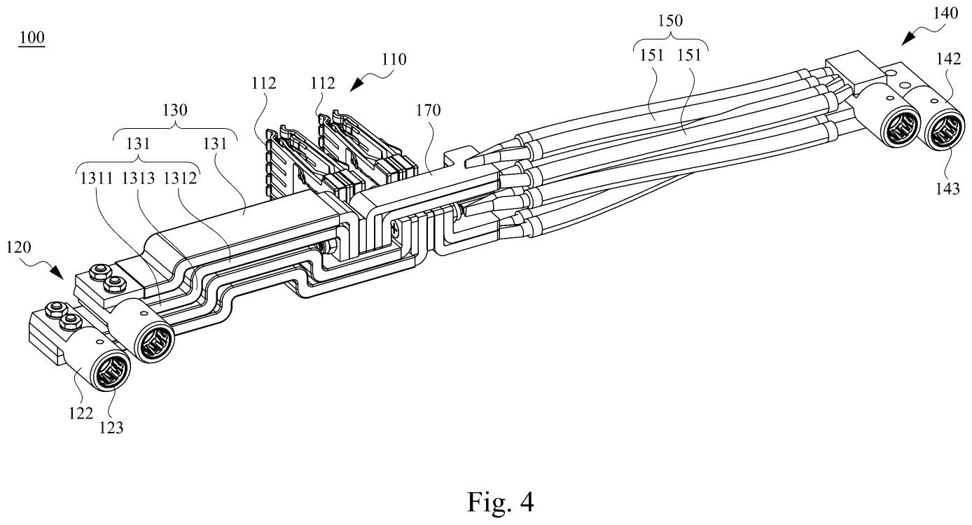

Please refer to FIGS. 3-4. FIG. 3 is a partially enlarged schematic view of the connector module 100 of FIG. 1. FIG. 4 is a schematic view of an internal structure of the connector module 100 of FIG. 3. In this embodiment, as shown in FIGS. 3-4, the busbar assembly 130 includes a plurality of busbars 131. The busbars 131 are respectively connected between the busbar connector 120 and the busbar clip connector 110. The cable assembly 150 includes a plurality of cables 151. The cables 151 are respectively connected between the cable connector 140 and the busbar clip connector 110.

It is worth to note that, in this embodiment, as shown in FIGS. 3-4, the busbars 131 of the busbar assembly 130 are respectively plate-shaped, while the cables 151 of the cable assembly 150 are respectively wire-shaped. Therefore, the stiffness of each of the busbars 131 is greater than the stiffness of each of the cables 151, meaning the busbars 131 are less prone to deformation compared to the cables 151. In other words, the bendability of each of the busbars 131 is less than the bendability of each of the cables 151. As the bendability is inversely related to the magnitude of moment of inertia of the sectional profile of an object, the moment of inertia of the sectional profile of each of the busbars 131 is larger than the moment of inertia of the sectional profile of each of the cables 151.

More specifically, in this embodiment, as shown in FIG. 4, at least one of the busbars 131 includes a first sub-busbar 1311, a second sub-busbar 1312, and a bending portion 1313. The first sub-busbar 1311 is connected to the busbar connector 120, the second sub-busbar 1312 is connected to the busbar clip connector 110, and the bending portion 1313 is connected between the first sub-busbar 1311 and the second sub-busbar 1312. The bending portion 1313 is at least partially bent. In this way, the first sub-busbar 1311 and the second sub-busbar 1312 can be positioned at different height levels based on the actual situation, enabling the busbar 131 and thus the busbar assembly 130 to achieve a better utilization of space.

Furthermore, as shown in FIG. 3, the busbar connector 120 and the busbar clip connector 110 are spaced apart from each other by a first distance X1, while the cable connector 140 and the busbar clip connector 110 are spaced apart from each other by a second distance X2. According to the actual situation, the first distance X1 and the second distance X2 are different from each other, enhancing the application flexibility of the connector module 100. For example, as shown in FIG. 3, the second distance X2 is greater than the first distance X1.

As mentioned above, since the busbar connector 120 connected to one side of the busbar clip connector 110 is connected via the busbar assembly 130, while the cable connector 140 connected to the other side of the busbar clip connector 110 is connected via the cable assembly 150, with the stiffness of each of the busbars 131 of the busbar assembly 130 being greater than the stiffness of each of the cables 151 of the cable assembly 150, the flexibility of the connector module 100 in equipment assembly applications is effectively enhanced.

Furthermore, in this embodiment, as shown in FIG. 4, the connector module 100 further includes a plurality of extension members 170. The extension members 170 are respectively connected between one of the cables 151 and one of the terminal sets 112, facilitating the connection between the cables 151 and the terminal sets 112. In practice, the extension members 170 are busbar structures. For example, each of the extension members 170 is an L-shaped plate structure with a bending section, where the angle of this bending section is substantially a right angle. However, the present disclosure is not limited thereto, and the angle of the bending section may also be an acute or obtuse angle.

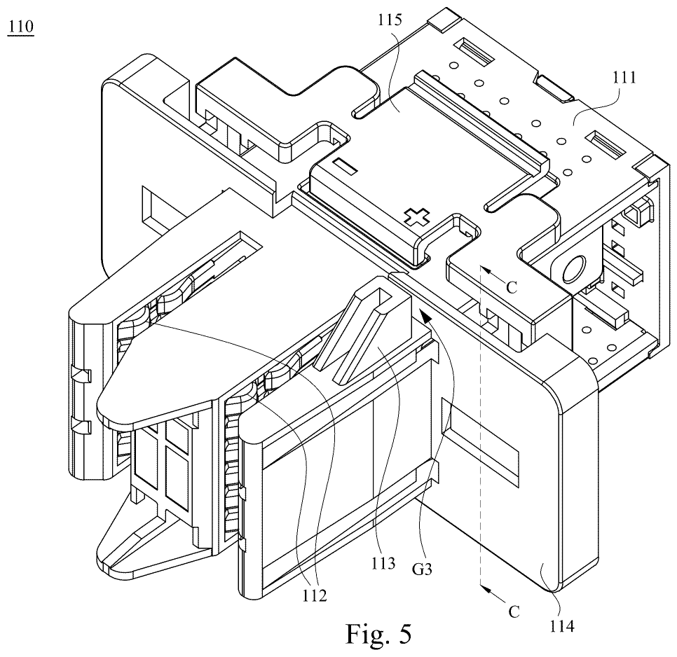

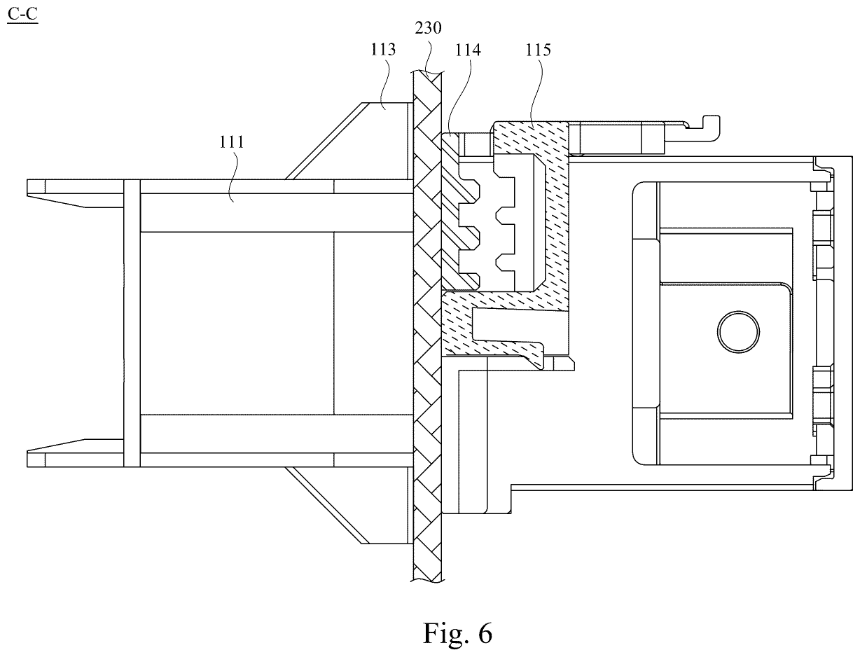

Please refer to FIGS. 4-6. FIG. 5 is an enlarged schematic view of the busbar clip connector 110 of FIG. 1, in which the pressing member 115 is in a third unlocked state. FIG. 6 is a sectional view along the sectional line C-C of FIG. 5, in which the pressing member 115 is in a third locked state. In this embodiment, as shown in FIGS. 4-6, the busbar clip connector 110 includes a fourth housing 111 and a plurality of terminal sets 112. The fourth housing 111 is configured to connect to the third panel 230. For the sake of drawing simplification, the third panel 230 is only shown in FIG. 6 but not in FIGS. 4-5. The terminal sets 112 are at least partially disposed within the fourth housing 111 and are spaced apart from each other. At least one of the busbars 131 is connected to one of the terminal sets 112, and at least another one of the busbars 131 is connected to another one of the terminal sets 112. Similarly, at least one of the cables 151 is connected to one of the terminal sets 112, and at least another one of the cables 151 is connected to another one of the terminal sets 112.

Furthermore, as shown in FIGS. 5-6, the busbar clip connector 110 further includes at least one fifth limiting portion 113, at least one sixth limiting portion 114, and a pressing member 115. The fifth limiting portion 113 and the sixth limiting portion 114 are respectively disposed outside the fourth housing 111 and spaced apart from each other to define a third gap G3 therebetween. The third gap G3 is configured to at least partially accommodate the third panel 230. The pressing member 115 is disposed on the fourth housing 111 and is at least partially located on a side of the sixth limiting portion 114 away from the fifth limiting portion 113. The pressing member 115 is configured to snap with the fourth housing 111 after moving relative to the fourth housing 111, so as to switch between a third unlocked state and a third locked state. When the pressing member 115 is in the third unlocked state, as shown in FIG. 5, the pressing member 115 is relatively far away from the fifth limiting portion 113. When the pressing member 115 is in the third locked state, i.e., when a user pushes the pressing member 115 from the position of the third unlocked state towards the fifth limiting portion 113, as shown in FIG. 6, the pressing member 115 at least partially penetrates through the sixth limiting portion 114 to get relatively close to the fifth limiting portion 113, and the pressing member 115 at least partially presses against the third panel 230, such that the busbar clip connector 110 can be securely fixed to the third panel 230. To detach the busbar clip connector 110 from the third panel 230, the user can push the pressing member 115 from the position of the third locked state to a direction away from the fifth limiting portion 113, such that the pressing member 115 returns to the third unlocked state and no longer presses against the third panel 230, allowing the user to detach the busbar clip connector 110 from the third panel 230.

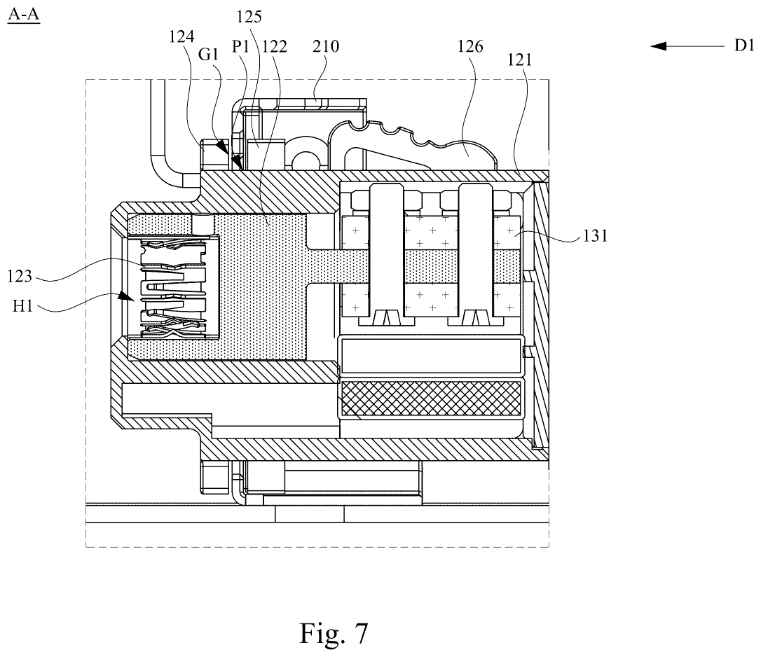

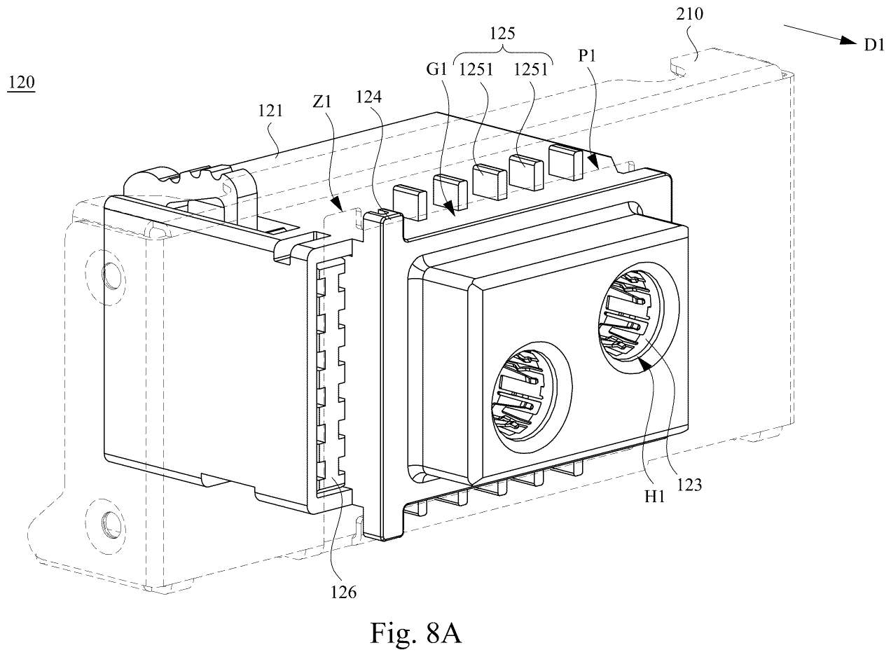

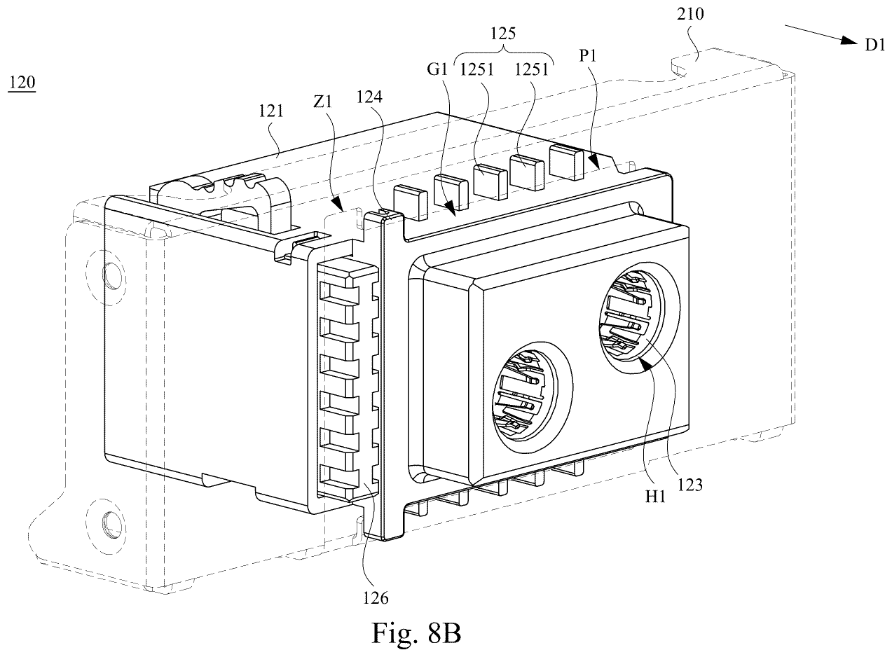

Please refer to FIGS. 7, 8A and 8B. FIG. 7 is a sectional view along the sectional line A-A of FIG. 1. FIG. 8A is an enlarged schematic view of the busbar connector 120 of FIG. 1, in which the first locking member 126 is in a first unlocked state. FIG. 8B is an enlarged schematic view of the busbar connector 120 of FIG. 1, in which the first locking member 126 is in a first locked state. In this embodiment, as shown in FIGS. 7, 8A and 8B, the busbar connector 120 includes a first housing 121, a plurality of first conductive portions 122 and a plurality of first conductive sleeves 123. The first housing 121 is configured to penetrate through a first hole P1 of the first panel 210 and connect to the first panel 210. The first conductive portions 122 are at least partially disposed within the first housing 121 and respectively have a first accommodating hole H1. The first conductive sleeves 123 are disposed within the first accommodating holes H1. For clarity, the first panel 210 is shown in dashed lines in FIGS. 8A and 8B. As shown in FIG. 4, at least one of the busbars 131 is connected to one of the first conductive portions 122, and at least another one of the busbars 131 is connected to another one of the first conductive portions 122.

Furthermore, as shown in FIGS. 7, 8A and 8B, the busbar connector 120 further includes at least one first limiting portion 124, at least one second limiting portion 125 and a first locking member 126. The first limiting portion 124 and the second limiting portion 125 are respectively disposed outside the first housing 121 and are spaced apart from each other along a first direction D1 to define a first gap G1 therebetween. The first gap G1 is configured to at least partially accommodate the first panel 210. In practice, the second limiting portion 125 includes a plurality of sub-limiting portions 1251 which are separated from each other and arranged transversely relative to the first direction D1. The sub-limiting portions 1251 and the first limiting portion 124 are offset from each other in the first direction D1. Therefore, when the busbar connector 120 penetrates through the first hole P1 of the first panel 210 along the first direction D1, the first limiting portion 124 can penetrate through a first clearance zone Z1 on the first panel 210 that corresponds and communicates with the first hole P1, while the sub-limiting portions 1251 of the second limiting portion 125 abut against the first panel 210 and do not penetrate through the first hole P1. After the first limiting portion 124 penetrates through the first clearance zone Z1, the busbar connector 120 can move relative to the first panel 210 in a direction perpendicular to the first direction D1 (which is a transverse movement relative to the first direction D1), causing the first limiting portion 124 to move away from the first clearance zone Z1. This allows the first panel 210 to be at least partially sandwiched between the first limiting portion 124 and the second limiting portion 125, such that the busbar connector 120 cannot be detached from the first panel 210 along the first direction D1. Furthermore, the first locking member 126 is disposed on the first housing 121 and is at least partially located on a side of the second limiting portion 125 away from the first limiting portion 124 in the first direction D1. The first locking member 126 is configured to move relative to the first housing 121 along the first direction D1 to switch between a first unlocked state and a first locked state. As shown in FIG. 8A, when the first locking member 126 is in the first unlocked state, the first locking member 126 is defined at a side of the first gap G1 relative to the second limiting portion 125 in the first direction D1 and is away from the first limiting portion 124. At this point, the first locking member 126 is located outside the first hole P1 of the first panel 210, and the busbar connector 120 can still move relative to the first panel 210 in a direction perpendicular to the first direction D1. As shown in FIG. 8B, when the first locking member 126 is in the first locked state, the first locking member 126 is closer to the first limiting portion 124 in the first direction D1 relative to the second limiting portion 125. At this point, the first locking member 126 at least partially abuts against the edge of the first panel 210 defining the first hole P1, such that the busbar connector 120 cannot move relative to the first panel 210 in a direction perpendicular to the first direction D1, thus completing the process of fixing the busbar connector 120 to the first panel 210.

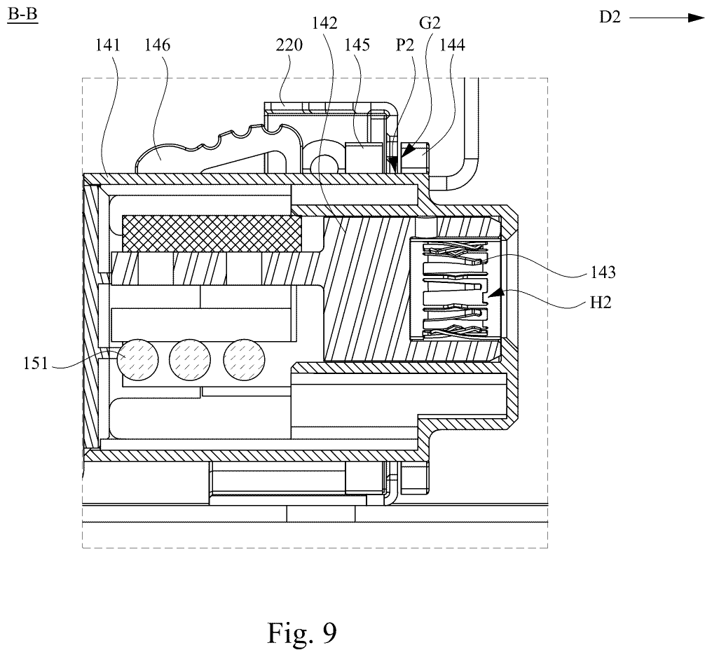

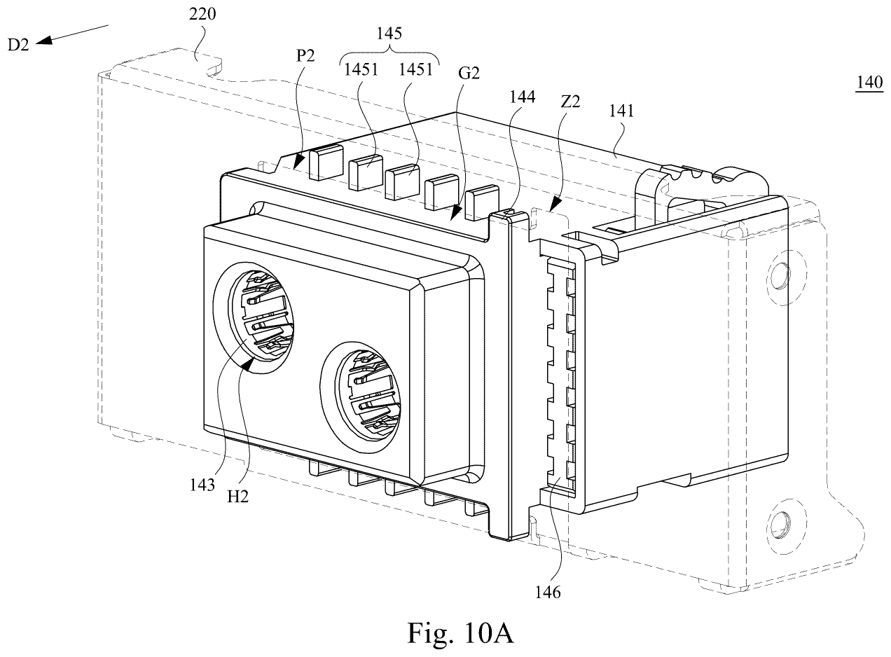

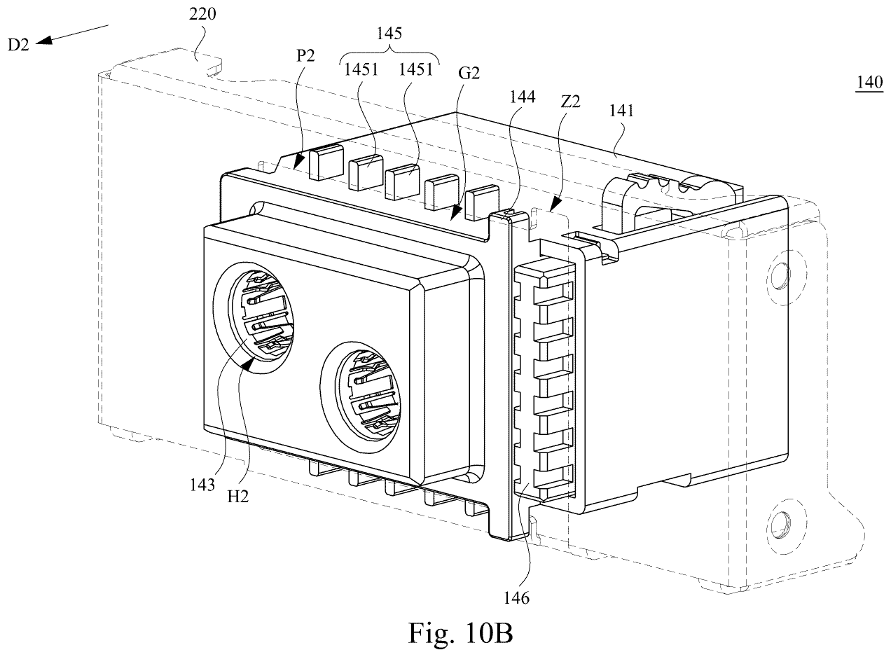

Please refer to FIGS. 9, 10A and 10B. FIG. 9 is a sectional view along the sectional line B-B of FIG. 1. FIG. 10A is an enlarged schematic view of the cable connector 140 of FIG. 1, in which the second locking member 146 is in a second unlocked state. FIG. 10B is an enlarged schematic view of the cable connector 140 of FIG. 1, in which the second locking member 146 is in a second locked state. In this embodiment, as shown in FIGS. 9, 10A and 10B, the cable connector 140 includes a second housing 141, a plurality of second conductive portions 142 and a plurality of second conductive sleeves 143. The second housing 141 is configured to penetrate through a second hole P2 of the second panel 220 and connect to the second panel 220. The second conductive portions 142 are at least partially disposed within the second housing 141 and respectively have a second accommodating hole H2. The second conductive sleeves 143 are disposed within the second accommodating holes H2. For clarity, the second panel 220 is shown in dashed lines in FIGS. 10A and 10B. As shown in FIG. 4, at least one of the cables 151 is connected to one of the second conductive portions 142, and at least another one of the cables 151 is connected to another one of the second conductive portions 142.

Furthermore, as shown in FIGS. 9, 10A and 10B, the cable connector 140 further includes at least one third limiting portion 144, at least one fourth limiting portion 145 and a second locking member 146. The third limiting portion 144 and the fourth limiting portion 145 are respectively disposed outside the second housing 141 and are spaced apart from each other along a second direction D2 to define a second gap G2 therebetween. The second gap G2 is configured to at least partially accommodate the second panel 220. In practice, the fourth limiting portion 145 includes a plurality of sub-limiting portions 1451 which are separated from each other and arranged transversely relative to the second direction D2. The sub-limiting portions 1451 and the third limiting portion 144 are offset from each other in the second direction D2. Therefore, when the cable connector 140 penetrates through the second hole P2 of the second panel 220 along the second direction D2, the third limiting portion 144 can penetrate through a second clearance zone Z2 on the second panel 220 that corresponds and communicates with the second hole P2, while the sub-limiting portions 1451 of the fourth limiting portion 145 abut against the second panel 220 and do not penetrate through the second hole P2. After the third limiting portion 144 penetrates through the second clearance zone Z2, the cable connector 140 can move relative to the second panel 220 in a direction perpendicular to the second direction D2 (which is a transverse movement relative to the second direction D2), causing the third limiting portion 144 to move away from the second clearance zone Z2. This allows the second panel 220 to be at least partially sandwiched between the third limiting portion 144 and the fourth limiting portion 145, such that the cable connector 140 cannot be detached from the second panel 220 along the second direction D2. Furthermore, the second locking member 146 is disposed on the second housing 141 and is at least partially located on a side of the fourth limiting portion 145 away from the third limiting portion 144 in the second direction D2. The second locking member 146 is configured to move relative to the second housing 141 along the second direction D2 to switch between a second unlocked state and a second locked state. As shown in FIG. 10A, when the second locking member 146 is in the second unlocked state, the second locking member 146 is defined at a side of the first gap G2 relative to the fourth limiting portion 145 in the second direction D2 and is away from the third limiting portion 144. At this point, the second locking member 146 is located outside the second hole P2 of the second panel 220, and the cable connector 140 can still move relative to the second panel 220 in a direction perpendicular to the second direction D2. As shown in FIG. 10B, when the second locking member 146 is in the second locked state, the second locking member 146 is closer to the third limiting portion 144 in the second direction D2 relative to the fourth limiting portion 145. At this point, the second locking member 146 at least partially abuts against the edge of the second panel 220 defining the second hole P2, such that the cable connector 140 cannot move relative to the second panel 220 in a direction perpendicular to the second direction D2, thus completing the process of fixing the cable connector 140 to the second panel 220. In practical applications, the first panel 210 and the second panel 220 are parallel to each other, meaning the first direction D1 is also parallel to the second direction D2, but the present disclosure is not limited thereto.

In this embodiment, as shown in FIGS. 1-2, the connector module 100 further includes a plurality of board end connectors 160. The board end connectors 160 are respectively connected to a circuit board 300 and are configured to connect to one of the busbar connector 120 and the cable connector 140. In practical applications, the circuit boards 300 may be printed circuit boards separated from each other. In other embodiments, according to the actual situation, the circuit boards 300 may be a single piece of printed circuit board, meaning the board end connectors 160 are connected to the same piece of printed circuit board.

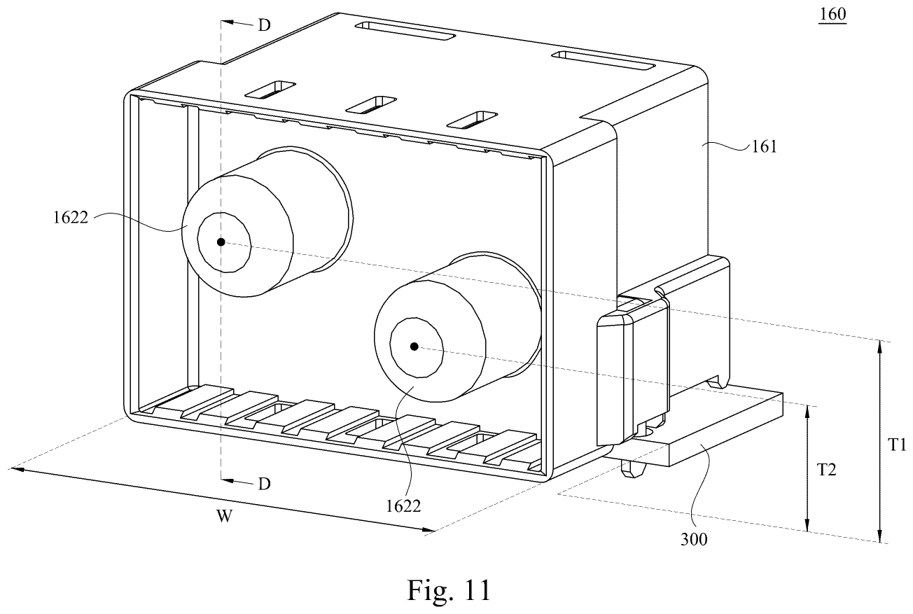

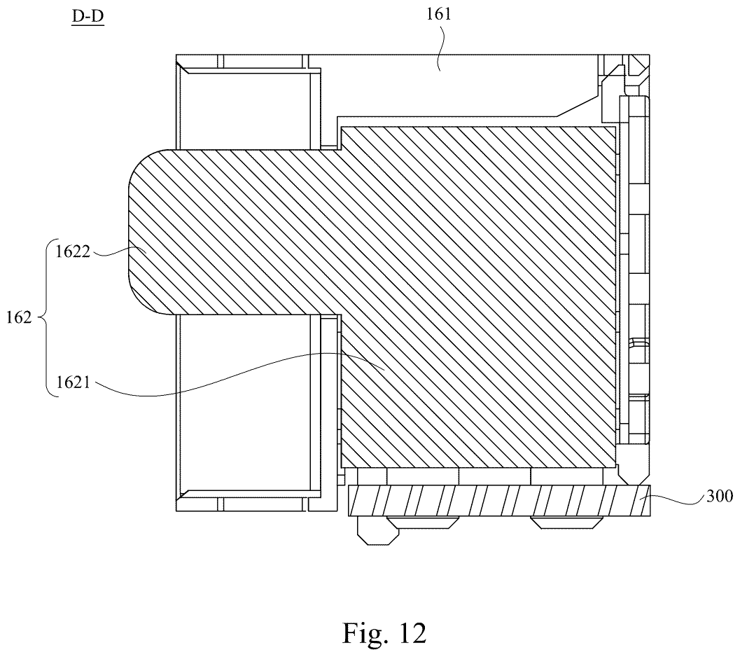

Please refer to FIGS. 11-12. FIG. 11 is an enlarged schematic view of the board end connector 160 of FIG. 1. FIG. 12 is a sectional view along the sectional line D-D of FIG. 11. In this embodiment, as shown in FIGS. 11-12, the board end connectors 160 respectively include a third housing 161 and a plurality of plug terminals 162. The third housing 161 is configured to connect to the circuit board 300. The plug terminals 162 respectively include a third conductive portion 1621 and a plug portion 1622. The third conductive portion 1621 is at least partially disposed within the third housing 161 and configured to electrically connect to the circuit board 300. The plug portion 1622 extends from the third conductive portion 1621 and is configured to be inserted into either the first conductive sleeve 123 of the busbar connector 120 or the second conductive sleeve 143 of the cable connector 140.

Furthermore, as shown in FIG. 11, the plug portion 1622 of one of the two plug terminals 162 has a first height T1 relative to the circuit board 300 in the normal direction of the circuit board 300, and the plug portion 1622 of another one of the two plug terminals 162 has a second height T2 relative to the circuit board 300 in the normal direction of the circuit board 300, in which the first height T1 is greater than the second height T2, meaning the first height T1 and the second height T2 are different from each other. In addition, the two plug portions 1622 are offset from each other in a level parallel with the circuit board 300. In other words, the two plug portions 1622 of the board end connector 160 are arranged in an inclined manner, which not only effectively reduces the width W of the board end connector 160 but also provides a foolproof effect when connecting the board end connector 160 to the busbar connector 120 or the cable connector 140.

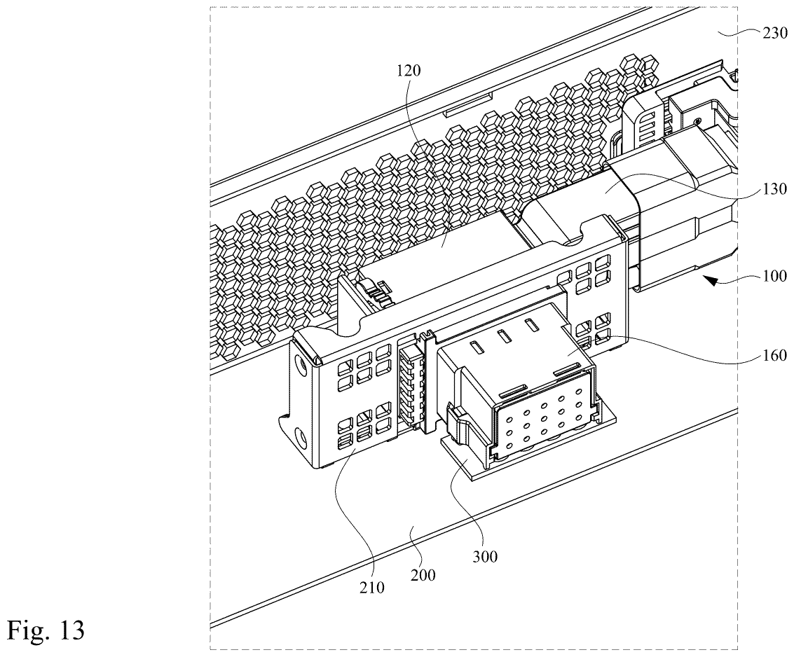

Please refer to FIG. 13. FIG. 13 is an enlarged schematic view of the busbar connector 120 and the corresponding board end connector 160 of FIG. 1 after being connected together. In this embodiment, as shown in FIG. 13, when the plug portion 1622 of the board end connector 160 is inserted into the first conductive sleeve 123 of the busbar connector 120 as described above, the third housing 161 of the board end connector 160 at least partially abuts against the first housing 121 of the busbar connector 120, completing the electrical connection between the board end connector 160 and the busbar connector 120. Similarly, the board end connector 160 and the cable connector 140 are connected in the same manner, and thus further description is omitted here.

It is worth to note that, as mentioned above, the processes of assembling and disassembling the busbar clip connector 110 to the third panel 230 of the chassis 200, the busbar connector 120 to the first panel 210 of the chassis 200, and the cable connector 140 to the second panel 220 of the chassis 200 do not involve additional hand tools, providing convenience for users.

In conclusion, the aforementioned embodiments of the present disclosure have at least the following advantages:
(1) Since the busbar connector connected to one side of the busbar clip connector is connected via the busbar assembly, while the cable connector connected to the other side of the busbar clip connector is connected via the cable assembly, with the stiffness of each of the busbars of the busbar assembly being greater than the stiffness of each of the cables of the cable assembly, the flexibility of the connector module in equipment assembly applications is effectively enhanced.
(2) Since the first distance of the busbar connector from the busbar clip connector and the second distance of the cable connector from the busbar clip connector are different from each other, the flexibility of the connector module in equipment assembly applications is further enhanced.
(3) Since the plug portions of each of the board end connectors are arranged in an inclined manner, this does not only effectively reduce the width of the board end connector but also provide a foolproof effect when connecting the board end connector to the busbar connector or the cable connector.
(4) Since the processes of assembling and disassembling the busbar clip connector to the third panel of the chassis, the busbar connector to the first panel of the chassis, and the cable connector to the second panel of the chassis do not involve additional hand tools, it is convenient for users.

Although the present disclosure has been described in considerable detail with reference to certain embodiments thereof, other embodiments are possible. Therefore, the spirit and scope of the appended claims should not be limited to the description of the embodiments contained herein.

It will be apparent to the person having ordinary skill in the art that various modifications and variations can be made to the structure of the present disclosure without departing from the scope or spirit of the present disclosure. In view of the foregoing, it is intended that the present disclosure cover modifications and variations of the present disclosure provided they fall within the scope of the following claims.

What is claimed is:

1. A connector module, comprising:
a busbar clip connector;
a busbar connector;
a busbar assembly connected with the busbar connector and a side of the busbar clip connector;
a cable connector; and
a cable assembly connected with the cable connector and another side of the busbar clip connector.

2. The connector module of claim 1, wherein the busbar assembly comprises a plurality of busbars, the busbars are respectively connected between the busbar connector and the busbar clip connector, the cable assembly comprises a plurality of cables, the cables are respectively connected between the cable connector and the busbar clip connector, a stiffness of each of the busbars is greater than a stiffness of each of the cables.

3. The connector module of claim 2, wherein at least one of the busbars comprises a first sub-busbar, a second sub-busbar and a bending portion, the first sub-busbar is connected to the busbar connector, the second sub-busbar is connected to the busbar clip connector, the bending portion is connected between the first sub-busbar and the second sub-busbar and is at least partially bent.

4. The connector module of claim 2, wherein the busbar connector comprises a first housing, a plurality of first conductive portions and a plurality of first conductive sleeves, the first housing is configured to connect to a first panel, the first conductive portions are at least partially disposed within the first housing and respectively have a first accommodating hole, the first conductive sleeves are disposed within the first accommodating holes, at least one of the busbars is connected to one of the first conductive portions, at least another one of the busbars is connected to another one of the first conductive portions, the cable connector comprises a second housing, a plurality of second conductive portions and a plurality of second conductive sleeves, the second housing is configured to connect to a second panel, the second conductive portions are at least partially disposed within the second housing and respectively have a second accommodating hole, the second conductive sleeves are disposed within the second accommodating holes, at least one of the cables is connected to one of the second conductive portions, at least another one of the cables is connected to another one of the second conductive portions.

5. The connector module of claim 4, further comprising a plurality of board end connectors, the board end connectors respectively comprising:
a third housing configured to connect to a circuit board; and
a plurality of plug terminals respectively comprising a third conductive portion and a plug portion, the third conductive portion being at least partially disposed within the third housing and configured to electrically connect to the circuit board, the plug portion extending from the third conductive portion,
wherein the plug portions of at least one of the board end connectors are configured to be inserted into one of the first conductive sleeves or the second conductive sleeves, the plug portions of at least another one of the board end connectors are configured to be inserted into another one of the first conductive sleeves or the second conductive sleeves.

6. The connector module of claim 5, wherein the plug portion of one of the plug terminals and the plug portion of at least another one of the plug terminals have different heights relative to the circuit board in a normal direction of the circuit board and are offset from each other at a level parallel with the circuit board.

7. The connector module of claim 4, wherein the busbar connector further comprises at least one first limiting portion, at least one second limiting portion and a first locking member, the first limiting portion and the second limiting portion are respectively disposed outside the first housing and offset from each other along a first direction, the first locking member is disposed on the first housing and at least partially located on a side of the second limiting portion away from the first limiting portion in the first direction, the first locking member is configured to move relative to the first housing along the first direction to switch between a first unlocked state and a first locked state.

8. The connector module of claim 4, wherein the cable connector further comprises at least one third limiting portion, at least one fourth limiting portion and a second locking member, the third limiting portion and the fourth limiting portion are respectively disposed outside the second housing and offset from each other along a second direction, the second locking member is disposed on the second housing and at least partially located on a side of the fourth limiting portion away from the third limiting portion in the second direction, the second locking member is configured to move relative to the second housing along the second direction to switch between a second unlocked state and a second locked state.

9. The connector module of claim 2, wherein the busbar clip connector comprises a fourth housing and a plurality of terminal sets, the terminal sets are at least partially disposed within the fourth housing and spaced apart from each other, at least one of the busbars is connected to one of the terminal sets, at least another one of the busbars is connected to another one of the terminal sets, at least one of the cables is connected to one of the terminal sets, at least another one of the cables is connected to another one of the terminal sets, the fourth housing is configured to connect to a third panel.

10. The connector module of claim 9, wherein the busbar clip connector further comprises at least one fifth limiting portion, at least one sixth limiting portion and a pressing member, the fifth limiting portion and the sixth limiting portion are respectively disposed outside the fourth housing and spaced apart from each other, the pressing member is disposed on the fourth housing and at least partially located on a side of the sixth limiting portion away from the fifth limiting portion, the pressing member is configured to move relative to the fourth housing to switch between a third unlocked state and a third locked state.

11. A connector module, comprising:
a busbar clip connector connected to a chassis;
a busbar connector connected to the chassis;
a plurality of busbars respectively connected between the busbar connector and a side of the busbar clip connector, each of the busbars having a first sectional profile defining a first moment of inertia;
a cable connector connected to the chassis; and
a plurality of cables respectively connected between the cable connector and another side of the busbar clip connector, each of the cables having a second sectional profile defining a second moment of inertia,
wherein the first moment of inertia is larger than the second moment of inertia.

12. The connector module of claim 11, wherein the busbars are respectively plate-shaped, the cables are respectively wire-shaped.

13. The connector module of claim 11, wherein the first sectional profile has two long edges and two short edges alternatively connected with each other, the busbars are arranged along an extending direction of the short edges.

14. The connector module of claim 11, wherein the busbar connector and the busbar clip connector are spaced apart from each other by a first distance, the cable connector and the busbar clip connector are spaced apart from each other by a second distance, the first distance and the second distance are different from each other.

15. The connector module of claim 11, further comprising:
a plurality of board end connectors respectively connected to a circuit board and configured to connect to one of the busbar connector and the cable connector.

16. The connector module of claim 11, further comprising:
a grounding wire connected between the busbar clip connector and the chassis.
